(19) United States
(12) Patent Application Publication
(10) Pub. No.: US 2018/0079249 A1
(43) Pub. Date: Mar. 22, 2018

(54) WALLET CARD DEVICE AND SYSTEM WITH DYNAMIC MAGNETIC STRIPE COMMUNICATIONS DEVICE

(71) Applicant: Dynamics Inc., Cheswick, PA (US)

(72) Inventors: Jeffrey D. Mullen, Glenshaw, PA (US); Kevin D. Bruner, New Kensington, PA (US); Allen D. Bowers, Aspenwall, PA (US)

(21) Appl. No.: 15/709,854

(22) Filed: Sep. 20, 2017

Related U.S. Application Data
(60) Provisional application No. 62/397,311, filed on Sep. 20, 2016.

(51) Int. Cl. B42D 25/21; B42D 25/305; G06Q 20/34; H01L 27/32

(52) U.S. Cl. CPC B42D 25/21; B42D 25/305; H01L 27/3237; G06Q 20/3576; G06Q 20/3572

(57) ABSTRACT

This application addressed a card comprising a memory operable to store a first card information and a second card information; a display operable to display user information; and a button operable to change a selected card from a first card to a second card and to change the user information from user information associated with the first card to user information associated with the second card.

### BACKGROUND OF THE INVENTION

This patent relates to wallet cards and related systems.

### SUMMARY OF THE INVENTION

### DESCRIPTION OF FIGURES

FIG. 1 is an illustration of cards and architectures in accordance with the principles of the present invention;

FIG. 2 is an illustration of devices in accordance with the principles of the present invention;

### DETAILED DESCRIPTION OF THE INVENTION

Currently, consumers carry multiple cards, for example, magnetic stripe cards, with them on a daily basis. It has gotten to the point that there is now a cottage industry dedicated to providing various carriers to hold these cards. To simplify consumer's lives and drive loyalty to a specific brand, what is needed is a single wallet card to replace one or more of these cards.

What is needed is a single wallet card, provided by an issuer, which provides the functions of one or more cards. In an embodiment, the wallet cards may be preloaded with multiple cards, for example multiple issuer cards or multiple network cards. In an embodiment, the wallet card may be updated wirelessly to add, remove, or modify, cards that are stored on the wallet card.

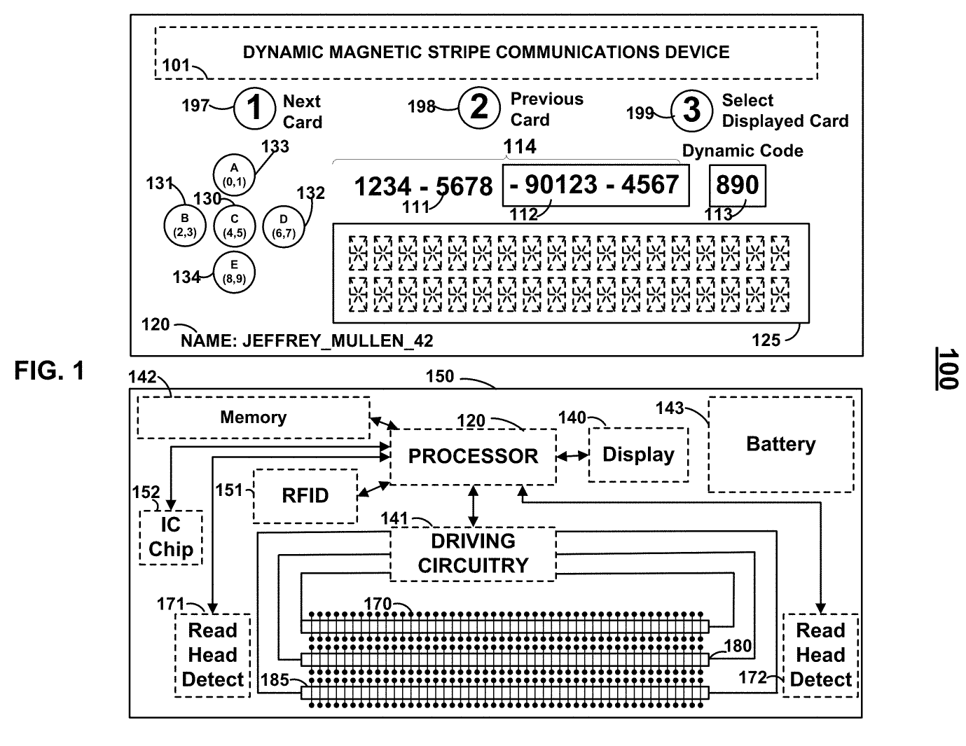

FIG. 1 shows cards and architectures according to example embodiments. Referring to FIG. 1, card 100 may include, for example, dynamic magnetic stripe communications device 101, one or more displays (e.g., displays 112, 113 and 125), permanent information 120, one or more buttons (e.g., buttons 130-134 and 197-199) and/or dynamic number 114. Dynamic number 114 may include permanent portion 111. Permanent portion 111 may be, for example, printed, embossed and/or laser etched on card 100.

Multiple displays may be provided on card 100 for various purposes. For example, display 112 may utilized to entirely, and/or partially, display a dynamic number. Display 113 may be utilized to display a dynamic code (e.g., a dynamic security code). Display 125 may display card information, logos, barcodes, holograms, and/or multiple lines of information. A display (e.g., at least one of displays 112, 113 and 125) may be a bi-stable display or non bi-stable display. A bi-stable display may be a display that maintains an image without power.

Permanent information 120 may include, for example, information specific to a user (e.g., a user's name and/or username) and/or information specific to a card (e.g., a card issue date and/or a card expiration date).

Buttons 131-134 and 197-199 may be mechanical buttons, capacitive buttons, or a combination of mechanical and capacitive buttons. Buttons 131-134 may be used, for example, to enter information (e.g., an access code) and/or to make a selection. For example, using buttons 131-134, a user may select options displayed on display 125 that instruct card 100 to communicate (e.g., via a dynamic magnetic stripe communications device, RFID and/or exposed IC chip) a user's instructions to use one of a debit account, a credit account, a pre-paid account, or a point account for a transaction (e.g., a payment transaction). According to at least one example embodiment, more than one account may be selected, for example, where a transaction may be divided between accounts. For example, card 100 may be utilized to indicate a user's desire to use a point account until the point account is exhausted and then a credit account.

Buttons 197 and 198 may be used, for example, to display a different card's information on more or more of the displays 112, 113, and 125. Persons skilled in the art will appreciate that pressing a button (e.g., button 199) may cause information to be communicated through device 101 when an associated read-head detector detects the presence of a read-head of a magnetic stripe reader. Button 199 may be utilized to communicate information indicative of a user selection.

A user may associate applications to buttons and/or features to applications, for example, on a graphical user interface (GUI). The graphical user interface may be, for example, an application manager provided by one or more entities. The associations may be changed, for example, at any time, periodically, and/or upon the occurrence of an event. According to some example embodiments, a user may associate applications to buttons and/or features to applications by telephone, by electronic mail and/or any other communication method.

Associations between buttons and service provider applications may be maintained by an ecosystem provider, for example, within an ecosystem of applications, transactional methods and types of transactions. When a transactional method (e.g., card 100) is used by a user, the ecosystem provider may receive transactional data and information indicative of a button selected by the user. The ecosystem provider may determine the identity of an application associated to the button, and may communicate some or all of the information and/or transactional data to the application and/or the service provider. The service provider and/or the application may provide a feature associated with the application based on the information and/or transactional data.

Architecture 150 may be utilized with any card (e.g., any card 100). Architecture 150 may include, for example, processor 120, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 120 may be any type of processing device, for example, a central processing unit (CPU) and/or a digital signal processor (DSP). Processor 120 may be, for example, an application specific integrated circuit (ASIC). Processor 120 may include on-board memory for storing information (e.g., drive code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120.

Memory 142 may be coupled to processor 120. Memory 142 may store data, for example, data that is unique to a particular card. Memory 142 may store any type of data. For example, memory 142 may store discretionary data codes associated with buttons of card 100. Discretionary data codes may be recognized by remote servers to effect particular actions. For example, a discretionary data code may be stored in memory 142 and may be used to cause a third party service feature to be performed by a remote server (e.g., a remote server coupled to a third party service such as an online voucher and/or coupon provider).

Different third party features may be, for example, associated with different buttons and a particular feature may be selected by pressing an associated button. According to some example embodiments, a user may select a third party feature from a list displayed to the user. For example, the user may scroll through a list of features on a display (e.g., a display on the front of the card). A user may scroll through a list using buttons on card 100. The list of features may be displayed to the user individually (e.g., one or more buttons may be used to change which feature is displayed), in groups and/or all features may be simultaneously displayed.

According to at least one example embodiment, a user may select a type of payment on card 100 via manual input interfaces. The manual input interfaces may correspond to displayed options (e.g., displayed on display 125) and/or may be independent buttons. Selected information may be communicated to a magnetic stripe reader via a dynamic magnetic stripe communications device. Selected information may also be communicated to a device (e.g., a mobile telephonic device) including a capacitive sensor and/or other type of touch sensitive sensor.

Architecture 150 may include any number of reader communication devices. For example, architecture 150 may include at least one of IC chip 150, RFID 151 and a magnetic stripe communications device. IC chip 150 may be used to communicate information to an IC chip reader (not illustrated). IC chip 150 may be, for example, an EMV chip. RFID 150 may be used to communicate information to an RFID reader. RFID 150 may be, for example, a RFID tag. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180, and 185 to communicate separate tracks of information to a magnetic stripe reader. Electromagnetic field generators 170, 180, and 185 may include a coil (e.g., each may include a coil) wrapped around one or more materials (e.g., a soft-magnetic material and a non-magnetic material). Each electromagnetic field generator may communicate information, for example, serially and/or in parallel to a receiver of a magnetic stripe reader for particular magnetic stripe track.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 120 to cause processor 120 to communicate information serially from electromagnetic generators 170, 180, and 185 to magnetic stripe track receivers in a read-head housing of a magnetic stripe reader.

According to at least one example embodiment, a magnetic stripe communications device may change the information communicated to a magnetic stripe reader at any time. Processor 120 may, for example, communicate user-specific and card-specific information through RFID 151, IC chip 150, and/or electromagnetic generators 170, 180, and 185 to card readers coupled to remote information processing servers (e.g., purchase authorization servers). Driving circuitry 141 may be utilized by processor 120, for example, to control electromagnetic generators 170, 180, and 185.

Architecture 150 may include, for example, a light sensor (not illustrated). Architecture 150 may receive information from a light sensor. Processor 120 may determine information received by a light sensor.

In an embodiment, a single wallet card operable to be loaded with information for one or more other cards, for example credit cards, debit cards, rewards cards, loyalty cards. An entity, for example an issuer, such as a bank, other financial institution, a network (like MasterCard® or Visa®), or a 3^{rd} party, would provide the wallet card. The wallet card can be provided with cards already loaded. In an embodiment, an EMV chip is provided on the card that is dynamic and can communicate information specific to a selected card.

In an embodiment, one or more of the displays, for example display 125 in FIG. 1, comprise e-paper. In an embodiment, displays comprising e-paper display information using a segmented display. In an embodiment, displays comprising e-paper display information using a pixilated display.

When active, the currently selected card information will be displayed, for example on display 125 of FIG. 1. The user may use buttons on the wallet card to cycle through stored cards. For example, there may be a single button that cycles sequentially through cards. In an embodiment, there may be two buttons that allow a user to cycle through cards in different orders, for example forward and backward though a sequence of cards. In other embodiments, there may be more than two buttons, for example a button for each card information stored on the wallet card. In an embodiment, logos associated with the financial institution or network associated with a specific account may also be displayed.

Once the user finds the information for the card they would like to use, he can use the wallet card as he would if he had that specific card. For example, the user may locate the information for an airline rewards credit card that he would like to use. Once that information is displayed, the user may swipe, tap, or otherwise conduct a payment transaction.

A dynamic magnetic stripe communications device on the wallet card will transmit the information related to the selected stored card. This may be communicated via a magnetic stripe emulator, magnetic stripe encoder, or wirelessly. In an embodiment, the wallet card may communicate and receive information using Bluetooth. In an embodiment, the wallet card may communicate and receive information via RFID. In an embodiment, the wallet card may communicate and receive information via the EMV chip. In an embodiment, the wallet card may communicate and receive information via LEDs and light sensors.

In an embodiment, the wallet card is updated by the party that issued the wallet card, not by the user. For example, the wallet card may be issued by a banking institution, a credit institution, or any other 3^{rd} party. The issuing party may preload one or more specific cards onto the wallet card. For example, a bank may initially load debit card information, cash-back credit card information, and airline rewards credit card information onto the wallet card. The user could then use the wallet card to conduct debit transactions or credit transactions which result in different rewards (in this case cash back or airline rewards). As needed, the issuing party may also modify the card information on the wallet card. For example, the user may cancel the airline rewards credit card. In this case, the issuing party would communicate instructions to the card to delete this account. In another example, the issuing party may update the cash-back credit card information, for example if the card expired and the user authorized the third part to issue a replacement card. In this case, the issuing party would communicate instructions to the card to modify this account. In another example, the user may indicate that it wishes to open a new account with the issuing party, for example a low-interest credit card. In this case, the issuing party would communicate instructions to the card to add this account to the accounts stored on the wallet card. In an embodiment, deleted, modified, or added information may include EMV information. In an embodiment, an EMV chip may communicate card specific information related to the selected card.

In an embodiment, a wallet card may be limited to a specific network. The wallet card may be issued by a specific network, or a third party may only be authorized to provide card information for cards from a specific network on a given wallet card. For example, a credit card company, such as Visa®, may issue a wallet card, but only permit that credit cards company's (or a select few card issuing companies) cards to be accessed using the wallet card. Such a wallet card may include additional branding information identifying the wallet card, for example holograms or other logos. Some of this information may appear on the display itself.

In an embodiment, a wallet card may be limited to a specific financial institution. The wallet card may be issued by a specific financial institution, for example a specific bank, and may only maintain cards provided by that specific financial institution. For example, a bank, such as Bank of America®, may issue a wallet card, but only permit that bank's (or a select few card issuing companies) cards to be accessed using the wallet card. Such a wallet card may include additional branding information identifying the wallet card, for example holograms or other logos. Some of this information may appear on the display itself.

In an embodiment, if certain conditions are met, the card may go to sleep, turning off the display and all dynamic magnetic stripe communications devices. In an embodiment, within a set amount of time after the card is last interacted with, it will go to sleep. In an embodiment, the card may include a on/off button that, when pressed, will either put the card to sleep or wake it up from sleep.

In an embodiment, the wallet card may also maintain and display information related to the rewards tier achieved by a user with respect to the selected card. In an embodiment, the tier may be displayed on the card, for example with the selected card information or on a separate display. In an embodiment, the issuer's logo may be modified to display the tier of the selected card. For example, if a user has achieved Visa Signature status for a specific card, the Visa logo may be modified to indicate that user has achieved Visa signature status for that card. In an embodiment, multiple tiers are possible, for example, Visa® basic, Visa Signature®, and Visa Black® or American Express Gold®, American Express Platinum®, American Express Reserve®, and American Express Black®.

In an embodiment, the user may achieve different tiers, rather than specific cards. In an embodiment, the user's status may be displayed, either with the card information or on a separate display. For example, MasterCard® may issue a wallet card, where all the cards are linked and accrue points towards MasterCard World Elite® status. Once a user has achieved this status, for example, by making enough purchases across all stored cards, the card may indicate that the user has achieved this status.

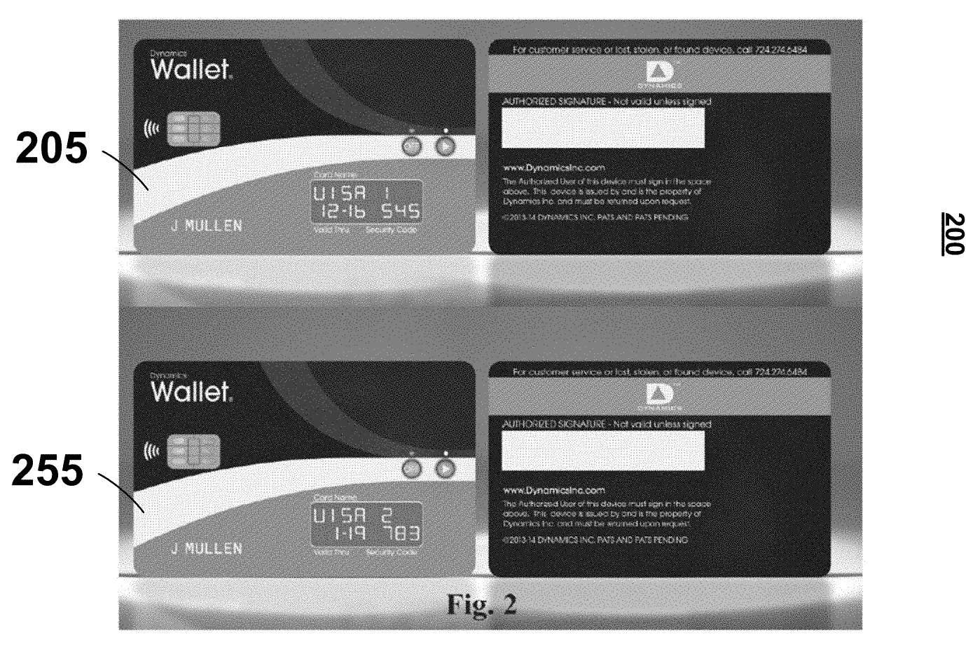

FIG. 2 shows a example wallet card according to example embodiments. Referring to FIG. 2, card 205 illustrates an exemplary wallet card prior to pushing a button on the wallet card. Card 255 illustrates the same exemplary wallet card after pushing a button on the wallet card. As described above, initially information regarding one stored card, in this case the Visa 1 card, is displayed. While not shown, additional information can be displayed to the user on the same or different displays. For example, the card number may be displayed in an embodiment. In an embodiment the Visa® logo may be displayed.

Prior to pressing the button, the EMV chip will communicate information associated with the Visa 1 card that is displayed on card 205. In an embodiment, the Visa 1 card information may also be communicated via multiple means, for example a dynamic magnetic stripe emulator, a dynamic magnetic stripe encoder, or wirelessly. In an embodiment, the Visa 1 card information may also be communicated wirelessly via Bluetooth, RFID, WiFi, light (using LEDs and light sensors), as well as other wireless communication means known to those skilled in the art.

After pressing the button, the EMV chip will communicate information associated with the Visa 2 card that is displayed on card 255. In an embodiment, the Visa 2 card information may also be communicated via multiple means, for example a dynamic magnetic stripe emulator, a dynamic magnetic stripe encoder, or wirelessly. In an embodiment, the Visa 2 card information may also be communicated wirelessly via Bluetooth, RFID, WiFi, light (using LEDs and light sensors), as well as other wireless communication means known to those skilled in the art.

Persons skilled in the art will appreciate that various elements of different example embodiments may be combined in various ways. Persons skilled in the art will also appreciate that the present invention is not limited to only the embodiments described. Instead, the present invention more generally involves dynamic information. Persons skilled in the art will also appreciate that the apparatus of the present invention may be implemented in other ways than those described herein. All such modifications are within the scope of the present invention, which is limited only by the claims that follow.

I claim:

1. A card comprising:
a memory operable to store a first card information and a second card information;
a display operable to display user information; and
a button operable to change a selected card from a first card to a second card and to change the user information from user information associated with the first card to user information associated with the second card.

2. The card of claim 1, wherein the display comprises e-paper.

3. The card of claim 1, wherein the display comprises e-paper using a segmented display.

4. The card of claim 1, wherein the display comprises e-paper using a pixilated display.

5. The card of claim 1, wherein the user information includes a payment authorization number.

6. The card of claim 1, wherein the user information includes a credit card number.

7. The card of claim 1, wherein the user information includes an expiration date.

8. The card of claim 1, wherein the user information includes security information.

9. The card of claim 1, wherein the user information includes a security number.

10. The card of claim 1, wherein the user information includes a card verification value.

11. The card of claim 1, wherein the user information includes a card verification code.

12. The card of claim 1, wherein the user information includes a card tier.

13. The card of claim 1, wherein the user information includes a dynamic security code.

14. The card of claim 1, wherein the user information includes a card network name.

15. The card of claim 1, wherein the user information includes a card network logo.

16. The card of claim 1, further comprising a dynamic magnetic stripe communication device.

17. The card of claim 1, further comprising a dynamic magnetic stripe communication device, wherein the dynamic magnetic stripe communication device emulates magnetic stripe information.

18. The card of claim 1, further comprising a dynamic magnetic stripe communication device, wherein the dynamic magnetic stripe communication device encodes magnetic stripe information.

19. The card of claim 1, further comprising a dynamic magnetic stripe communication device, wherein the dynamic magnetic stripe communication is associated with the first card.

20. The card of claim 1, further comprising a dynamic magnetic stripe communication device, wherein the button is operable to change the dynamic magnetic stripe communication to be associated with the second card.

21. The card of claim 1, further comprising a second button operable to change the selected card from the second card to the first card and to change the user information from user information associated with the second card to user information associated with the first card.

22. The card of claim 1, further comprising a second button operable to toggle the selected card between the first and the second card and to toggle the user information between user information associated with the second card and user information associated with the first card.

23. The card of claim 1, further comprising a wireless communication device.

24. The card of claim 1, further comprising a wireless communication device operable to communicate using Bluetooth.

25. The card of claim 1, further comprising a wireless communication device operable to communicate using RFID.

26. The card of claim 1, further comprising a wireless communication device operable to communicate using WiFi.

27. The card of claim 1, further comprising a wireless communication device operable to communicate using light.

28. The card of claim 1, further comprising a wireless communication device operable to communicate at least one of Bluetooth, RFID, WiFi, and light.

29. The card of claim 1, further comprising a EMV chip operable to communicate EMV information associated with the first card.

30. The card of claim 1, further comprising a EMV chip operable to communicate EMV information associated with the selected card.

31. The card of claim 1, further comprising a wireless communication device operable to receive update information.

32. The card of claim 1, further comprising:
a wireless communication device operable to receive update information; and
a processor operable to control the memory,
wherein the processor is operable to remove the first card information from memory based on the update information.

33. The card of claim 1, further comprising:
a wireless communication device operable to receive update information; and
a processor operable to control the memory,
wherein the processor is operable to modify the first card information in memory based on the update information.

34. The card of claim 1, further comprising:
a wireless communication device operable to receive update information; and
a processor operable to control the memory,
wherein the processor is operable to add a third card information to memory based on the update information.

35. The card of claim 1, wherein the first and second card information as associated with a same network.

36. The card of claim 1, wherein the first and second card information as associated with a same financial institution.

37. The card of claim 1, wherein the first and second card information as associated with a same bank.

38. The card of claim 1, further comprising a second display configured to display the user's tier.

39. The card of claim 1, wherein the display is further operable to display the user's tier.
